(19) United States
(12) Patent Application Publication
(10) Pub. No.: US 2026/0320521 A1
(43) Pub. Date: Oct. 15, 2026

(54) DATA AGGREGATION AND VISUALIZATION SYSTEM

(71) Applicant: Palantir Technologies Inc., Denver, CO (US)

(72) Inventors: Will Hammond, New York, NY (US); Jessica Jakoby, Pleasanton, CA (US); Diana Voevodsky, Belmont, MA (US); Alden Cheung, Brooklyn, NY (US)

(21) Appl. No.: 19/254,418

(22) Filed: Jun. 30, 2025

Related U.S. Application Data
(60) Provisional application No. 63/786,830, filed on Apr. 10, 2025.

(51) Int. Cl. G06Q 10/0631

(52) U.S. Cl. CPC G06Q 10/06315; G06Q 10/0631; G06Q 10/06312; G06Q 10/067; G06Q 10/08; G06Q 10/087; G06Q 10/0872; G06Q 10/08744; G06Q 10/08772; H04W 4/029; H04W 4/35

(57) ABSTRACT

A computer-implemented method may include: obtaining hierarchy information indicative of a hierarchy of a plurality of entities; receiving resource information about a resource used by the plurality of entities; determining that a first entity and a second entity are lower than a third entity in the hierarchy; determining that the first entity is associated with a first quantity of the resource and the second entity is associated with second quantity of the resource; determining that the third entity is associated with third quantity of the resource based at least on the first quantity and the second quantity; generating an interactive graph comprising nodes to represent at least some of the plurality of entities and indicate the resource information; and providing the interactive graph via a user interface.

### CROSS-REFERENCE TO RELATED APPLICATIONS

This application claims benefit of U.S. Provisional Patent Application No. 63/786830, filed Apr. 10, 2025, and titled “DATA AGGREGATION AND VISUALIZATION SYSTEM.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data integration, analysis, and visualization. More specifically, some embodiments of the present disclosure relate to hierarchical resource aggregation and associated interactive graph visualizations.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Organizations often need to manage resources associated with various units, divisions, or departments under their hierarchical structures to satisfy operational needs. For example, a unit at a higher hierarchy of a logistics company may need to aggregate and track supplies available to units at a lower hierarchy for ensuring a robust supply chain. For many organizations, managing resources such as supplies and personnel across complex hierarchical structures effectively and timely can present significant challenges.

### SUMMARY

The systems, methods, and devices described herein each have several aspects, no single one of which is solely responsible for its desirable attributes. Without limiting the scope of this disclosure, several non-limiting features will now be described briefly.

Organizations often need to manage resources associated with various units, divisions, or departments under their hierarchical structures to satisfy operational needs. For example, a unit at a higher hierarchy of a logistics company may need to aggregate and track supplies available to units at a lower hierarchy for ensuring a robust supply chain. However, it may be difficult for an organization to maintain accurate or real-time overview of resources under its organizational hierarchy to support certain operations (e.g., urgent or time sensitive operations such as disaster relief). For example, currently there may be no efficient way for a personnel of an organization to view aggregated statistics, trends, forecasts, conditions, and/or other details about resources distributed across a hierarchical organization structure to timely make informed decisions or take appropriate responses. Furthermore, current solutions often fail to offer a comprehensive view of resources available or requested across a hierarchy of an organization, or fall short of integrating various data sources to enable effective tracking and monitoring of resources. Additionally, it may be desirable to provide integrated, automatic, and/or interactive graphical visualizations for a user to interact with so as to enhance operational efficiency and responsiveness of an organization under complex and rapidly changing scenarios.

The present disclosure describes systems and methods (generally collectively referred to herein as a “data aggregation and visualization system” or simply a “system”) that can advantageously overcome various of the technical challenges mentioned above, among other technical challenges. More specifically, various implementations of the systems and methods of the present disclosure can advantageously utilize interactive graphical visualization, data processing techniques (e.g., automatic data aggregation), an ontology (e.g., a data model of objects, links between objects, and/or the like), and/or machine learning techniques (e.g., forecast based on historical data using a machine learning model) to automatically aggregate data for providing users with a comprehensive view of resource counts and other related information.

For example, the system can access data from multiple data sources to receive information (e.g., names, quantities, amount, conditions, and/or the like) about resources (e.g., material, equipment, manpower, and/or the like) used by or associated with entities (e.g., units, personnels, divisions, departments, teams) across a hierarchy of an organization. Based on information about resources and hierarchy information (e.g., information indicating that a unit has a higher authority or is in a higher hierarchical level than another unit) of the organization, the system can determine quantity information of a resource associated with entities in a lower hierarchical level. The system can further automatically aggregate the quantity information of the resource associated with entities in the lower hierarchical level to determine quantity information of entities that are in a higher hierarchical level. Based on hierarchy information and aforementioned quantity information, the system can generate an interactive graph comprising nodes (e.g., representing entities) and edges (e.g., representing connections between entities) to indicate or present quantity and other information (e.g., trends, forecasts, conditions, and/or the like of resources) about the resource across the hierarchy of the organization.

Advantageously, the system may enable users associated with an organization having complex hierarchical structures (e.g., many levels and/or branches) to view through an integrated computer environment (e.g., a web-based interface) aggregated statistics, trends, forecasts, conditions about resources that are used by entities across a hierarchical organizational structure. By accessing and integrating information about resources from multiple data sources, the system can also offer real-time insights about resources (e.g., supply metrics, demand information). As such, the system can enable users associated with the organization to access most current data for making informed decisions or taking responses timely. Additionally, the system can enable users to create custom views of their organization hierarchies, allowing them to generate counts, trends, alerts, and/or the like regarding the availability and event history of resources used across different levels of the organization's hierarchy. For example, a user may organize units of an organization in a different hierarchy than an organizational standard, or may leave out certain units to aggregate and visualize data associated with certain units and/or sub-units of a unit that the user is interested in or authorized to access. Based on a hierarchy organized or defined by the user, the system can automatically aggregate data based on the hierarchy and generate customized views showing information of resources to the user. The system can further allow users to configure settings or metrics related to data sources, statistics, resources, and/or the like, and to view individual entity nodes within the organization's hierarchy for managing resources relevant to the users' operations. Besides automatically accessing resource information from multiple data sources, the system can provide a submission portal for users to update resource counts (e.g., supply counts, demand counts) using files storing resource information. The system can also enable users to manually overwrite information about resources (e.g., manually update quantity of a resource) and/or toggle different data sources on and off, allowing the users to customize their operating picture based on preferred sources of truth.

Various embodiments of the present disclosure provide improvements to various technologies and technological fields. For example, as described above, the system may advantageously utilize data analysis, data processing, and/or machine learning techniques to automatically aggregate data for providing users with a comprehensive view of resource counts and other related information. Other technical benefits provided by various embodiments of the present disclosure include, for example, utilizing interactive graphs comprising nodes (e.g., representing entities) and edges (e.g., representing connections between entities) to indicate or present quantity and other information (e.g., trends, forecasts, conditions, and/or the like of resources) about the resource across the hierarchy of the organization.

Additionally, various implementations of the present disclosure are inextricably tied to computer technology. In particular, various implementations rely on detection of user inputs via graphical user interfaces, calculation of updates to displayed electronic data based on those user inputs, automatic processing of related electronic data, application of language models and/or other artificial intelligence, and provision of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various implementations cannot reasonably be performed by humans alone, without the computer technology upon which they are implemented. Further, the implementation of the various implementations of the present disclosure via computer technology enables many of the advantages described herein.

According to various implementations, large amounts of data (e.g., quantity information associated with certain resources obtained from multiple data sources) may be automatically and dynamically processed interactively in response to user inputs, and the processed data is efficiently and compactly presented to a user through interactive user interfaces of the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program or a software application (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data (e.g., data stored in an ontology associated with the system), and may enable the system to more quickly and accurately determine, access, navigate, assess, and/or digest the model-related data than previous systems.

Further, the interactive and dynamic user interfaces described herein are enabled by innovations in efficient interactions between the user interfaces and underlying systems and components. For example, disclosed herein are improved methods that execute data analysis, data processing, and/or machine learning techniques to perform interactive analysis and/or generate interactive node graphs or graphical visualizations comprising nodes and edges to provide interactive visualizations of entities across a hierarchy of an organization along with information of resources used by the entities. According to various implementations, the system (and related processes, functionality, and interactive graphical user interfaces) can advantageously offer real-time insights about resources (e.g., supply metrics, demand information) through interactive graphical representations. As such, an interactive graphical representation that includes nodes and edges to convey information of resources (e.g., quantity, status, and/or the like) can be more accurate, less complicated, and/or optimized.

Thus, various implementations of the present disclosure can provide improvements to various technologies and technological fields, and practical applications of various technological features and advancements. For example, as described above, existing data management and aggregation technology is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., automatically aggregating data from multiple data sources, generating or utilizing machine learning models to fulfill specific user requests, processing and analysis of large amounts of electronic data, management of data migrations and integrations, and/or the like) are intimately tied to, and enabled by, computer technology, and would not exist except for computer technology. Further, the implementation of the various implementations of the present disclosure via computer technology enables many of the advantages described herein, including more efficient management of various types of electronic data (including computer-based models).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums or devices comprising, configured to store, and/or storing program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above-and/or below-described implementations (including one or more aspects of the appended claims) are implemented and/or performed.

In various implementations, computer program products comprising one or more computer-readable storage mediums or devices, and/or one or more computer-readable storage mediums or devices, are disclosed, wherein the computer-readable storage mediums comprise, are configured to store, and/or store program instructions, the program instructions executable by one or more processors to cause the one or more processors to perform operations comprising one or more aspects of the above-and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a block diagram illustrating an example data aggregation and visualization system in an example computing environment, according to various implementations of the present disclosure;

FIG. 2 shows an example block diagram of example aspects of the data aggregation and visualization system, according to various embodiments of the present disclosure;

FIG. 3 illustrates an object-centric conceptual data model, according to various embodiments of the present disclosure;

FIG. 4 is a flowchart illustrating example routines for generating interactive graphical visualizations to provide information of a resource used by entities in a hierarchy of an organization, according to various embodiments of the present disclosure;

FIG. 5 is a flowchart illustrating example routines for updating information of a resource used by entities in a hierarchy of an organization based on user operation, according to various embodiments of the present disclosure;

FIGS. 6, 7, 8, 9, and 10 show example interactive graphical user interfaces associated with the data aggregation and visualization system, according to various implementations of the present disclosure; and

FIG. 11 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

As mentioned above, organizations often need to manage resources associated with various units, divisions, or departments under their hierarchical structures to satisfy operational needs. For example, a unit at a higher hierarchy of a logistics company may need to aggregate and track supplies available to units at a lower hierarchy for ensuring a robust supply chain. However, it may be difficult for an organization to maintain accurate or real-time overview of resources under its organizational hierarchy to support certain operations (e.g., urgent or time sensitive operations such as disaster relief). For example, currently there may be no efficient way for a personnel of an organization to view aggregated statistics, trends, forecasts, conditions, and/or other details about resources distributed across a hierarchical organization structure to timely make informed decisions or take appropriate responses. Furthermore, current solutions often fail to offer a comprehensive view of resources available or requested across a hierarchy of an organization, or fall short of integrating various data sources to enable effective tracking and monitoring of resources. Additionally, it may be desirable to provide integrated, automatic, and/or interactive graphical visualizations for a user to interact with so as to enhance operational efficiency and responsiveness of an organization under complex and rapidly changing scenarios.

As also noted above, the present disclosure describes systems and methods (generally collectively referred to herein as a “data aggregation and visualization system” or simply a “system”) that can advantageously overcome various of the technical challenges mentioned above, among other technical challenges. More specifically, various implementations of the systems and methods of the present disclosure can advantageously utilize interactive graphical visualization, data processing techniques (e.g., automatic data aggregation), an ontology (e.g., a data model of objects, links between objects, and/or the like), and/or machine learning techniques (e.g., forecast based on historical data using a machine learning model) to automatically aggregate data for providing users with a comprehensive view of resource counts and other related information. For example, the system can access data from multiple data sources to receive information (e.g., names, quantities, amount, conditions, and/or the like) about resources (e.g., material, equipment, manpower, and/or the like) used by or associated with entities (e.g., units, personnels, divisions, departments, teams) across a hierarchy of an organization. Based on information about resources and hierarchy information (e.g., information indicating that a unit has a higher authority or is in a higher hierarchical level than another unit) of the organization, the system can determine quantity information of a resource associated with entities in a lower hierarchical level. The system can further automatically aggregate the quantity information of the resource associated with entities in the lower hierarchical level to determine quantity information of entities that are in a higher hierarchical level. Based on hierarchy information and aforementioned quantity information, the system can generate an interactive graph comprising nodes (e.g., representing entities) and edges (e.g., representing connections between entities) to indicate or present quantity and other information (e.g., trends, forecasts, conditions, and/or the like of resources) about the resource across the hierarchy of the organization.

Advantageously, the system may enable users associated with an organization having complex hierarchical structures (e.g., many levels and/or branches) to view through an integrated computer environment (e.g., a web-based interface) aggregated statistics, trends, forecasts, conditions about resources that are used by entities across a hierarchical organizational structure. By accessing and integrating information about resources from multiple data sources, the system can also offer real-time insights about resources (e.g., supply metrics, demand information). As such, the system can enable users associated with the organization to access most current data for making informed decisions or taking responses timely. Additionally, the system can enable users to create custom views of their organization hierarchies, allowing them to generate counts, trends, alerts, and/or the like regarding the availability and event history of resources used across different levels of the organization's hierarchy. For example, a user may organize units of an organization in a different hierarchy than an organizational standard, or may leave out certain units to aggregate and visualize data associated with certain units and/or sub-units of a unit that the user is interested in or authorized to access. Based on a hierarchy organized or defined by the user, the system can automatically aggregate data based on the hierarchy and generate customized views showing information of resources to the user. The system can further allow users to configure settings or metrics related to data sources, statistics, resources, and/or the like, and to view individual entity nodes within the organization's hierarchy for managing resources relevant to the users' operations. Besides automatically accessing resource information from multiple data sources, the system can provide a submission portal for users to update resource counts (e.g., supply counts, demand counts) using files storing resource information. The system can also enable users to manually overwrite information about resources (e.g., manually update quantity of a resource) and/or toggle different data sources on and off, allowing the users to customize their operating picture based on preferred sources of truth.

### Example Features Related to Data Aggregation

The system can automatically aggregate data for providing users with real-time and comprehensive views of resource counts and other resource related information, thereby enabling users to effectively manage resources (e.g., dispatch, track, query, procure, and/or the like). In some examples, the system can access multiple data sources to receive data including information about resources used by an organization. Data including information about resources received from data sources may include any type of electronic data, such as text, files, documents, books, manuals, emails, images, audio, video, databases, metadata, positional data (e.g., geo-coordinates), sensor data, web pages, time series data, and/or any combination of the foregoing and/or the like. In some examples, information about resources may be stored in the form of a spreadsheet, a table, a list, and/or any other formats. The system can access data from data sources to receive information (e.g., name, quantity, condition, place of storage, and/or the like) about resources (e.g., raw material, medical equipment, manpower, and/or the like) that may be used by or associated with entities (e.g., units, personnels, divisions, departments) across a hierarchy of an organization. The system may automatically aggregate information about resources from multiple data sources to generate accurate and up-to-date information of resource.

In some examples, the system may continually monitor updates to data sources accessed by the system. For example, through an application programming interface (API) or other software tools and services for interacting with data storage systems associated with the data sources, the system may periodically monitor any update to data sources. When an update to a data source is detected, the system can automatically access updated information and generate updated resource counts by aggregating at least updated information.

In some examples, the system can allow users to toggle data sources on and off for customizing user views based on preferred sources. For example, responsive to a user operation toggling on a first data source and toggling off a second data source, the system can automatically aggregate resource information (e.g., resource counts) based at least on the first data source, but not based on the second data source. As noted above, the system can also enable users to manually overwrite information about resources (e.g., manually update quantity of a resource through a user interface).

The system can also detect if there is any conflict of resource information received from various data sources. For example, the system can detect that quantity information about a medical equipment received from a first data source is different from that received from a second data source. In this example, the system can choose to use quantity information from the data source that was most recently updated. Alternatively, the system can choose one data source over another (e.g., the first data source) if there is any indication (e.g., based on user reviews, past aggregation statistics) that the first data source is more trustworthy than the second data source.

### Example Features Related to Hierarchical Interactive Graph Generation

As noted above, the system may generate interactive node graphs or graphical visualizations comprising nodes and edges to provide interactive visualizations of entities across a hierarchy of an organization along with information of resources used by the entities. The system can access hierarchy information indicative of a hierarchy of an organization. The hierarchy information can be used to determine the relationships between different entities in the hierarchy of the organization, such as which entities are at a lower level and which are at a higher level within the hierarchy.

In some examples, the hierarchy information can be represented using any data structure or structured format (e.g., using data models or schemas that define the entities and their hierarchical relationships, or using other data storage formats such as JavaScript Object Notation (“JSON”)) that enables the system to analyze and determine relationships between entities. In some examples, the hierarchy information can be stored as a data object in an ontology associated with the system. The system may access the data object in the ontology, and parse or traverse the hierarchy information to determine, for example, relationships between entities of an organization. In some examples, the system may optionally utilize machine learning models (e.g., large language models (LLMs)) to parse or traverse hierarchy information of an organization that may have complex hierarchical structures. Further, an LLM and/or other artificial intelligence, may analyze organizational information (e.g., documents or data files of various formats) to generate a hierarchy of an organization and/or to periodically validate current hierarchy information of the organization. Based on the hierarchy information, the system can perform various operations, such as aggregating resource quantities across different levels of the hierarchy or generating interactive graphs that visually represent the hierarchy and associated data to enable users to view, analyze, or otherwise manage aggregated statistics and trends across the organizational hierarchy.

For example, based on hierarchy information indicative of a hierarchy of an organization, the system can determine that a first entity (e.g., a functional team) and a second entity (e.g., a design team) are in a lower level of the hierarchy and a third entity (e.g., a corporate unit) is in a higher level of the hierarchy. The system can further aggregate resource information associated with the first entity and the second entity to determine resource information associated with the third entity. For example, based on resource information received from various data sources, the system can determine that the first entity is associated with a first quantity or amount of a raw material (e.g., the first entity has in its possession 300 kilograms of copper, but has a need of 600 kilograms of copper), and that the second entity is associated with a second quantity or amount of a raw material (e.g., the second entity has in its possession 150 kilograms of copper, but has a need of 300 kilograms of copper). Based on the first quantity and the second quantity, the system can determine that the third entity is associated with a third quantity or amount of the raw material. For example, by aggregating the first quantity and the second quantity, the system can automatically determine that the third entity has under its disposal 450 kilograms of copper but has a need of 900 kilograms of copper.

Based on the hierarchy information, the quantities or amounts of resources associated with entities across a hierarchy of an organization, the system can generate an interactive graph representing the hierarchy and comprising nodes and/or edges to represent the entities of the organization along with hierarchical relationships among the entities. By performing various operations (e.g., select, drag, move, group, or the like) on the nodes or edges of the interactive graph and/or other user interface elements of a user interface that presents the interactive graph, users associated with the organization may customize their interactions with the system to focus on various aspects of resource information based on their objectives and/or roles in the hierarchy of the organization.

### Example Features Related to Data Objects

The system may employ database(s) that uses ontology and data objects to store, represent and/or organize data utilized by the system. For example, the system may collect, update, and add hierarchy and/or resource information into an ontology associated with a database. As such, data utilized by the system may be organized and/or linked to relevant context for providing a comprehensive knowledge base for data aggregation, analysis, reference, and/or the like.

In some embodiments, a body of data may be conceptually structured according to an object-centric data model represented by an ontology. The ontology may include stored information providing a data model for storage of data in the database. The ontology may be defined by one or more object types, which may each be associated with one or more property types. At the highest level of abstraction, data object may be a container for information representing things in the world. For example, data object can represent a resource (e.g., raw material, equipment, supply, personnel, and/or the like), a hierarchy of an organization, a document or other unstructured data source such as an e-mail message, a news report, or a written paper or article. Additionally, data object can represent an entity such as a person, a place, a department, a division, an organization, a market instrument, or other noun. Data object can further represent an event that happens at a point in time or for a duration. Each data object may be associated with a unique identifier that uniquely identifies the data object within the database of the system.

### Example Features Related to User Interfaces

The system may further allow user to interact with the system through an interactive user interface (e.g., a graphical user interface (“GUI”) or other types of user interfaces), and receive user operations on an interactive graphical visualization that is presented through the interactive user interface. As noted above, the system may use one or more interactive user interfaces to present the interactive graphical visualization associated with resources used by entities of an organization. The interactive user interface may allow users to make selections on nodes, edges, and/or user interface elements within the interactive graphical visualization. For example, selecting a user interface element may cause the system to generate a forecast on shortage of a resource in the next 24 hours, 48 hours, or other interested future periods of time. As noted above, through a user interface, the system can optionally provide a submission portal for users to update resource counts (e.g., supply counts, demand counts) using files storing resource information.

Additionally and/or optionally, the system may provide an interactive user interface to enable users to perform other operations. For example, the interactive user interface may enable users to edit (e.g., through adding or removing nodes from an interactive graph) hierarchy of an organization. As another example, by operating on user interface elements representing resources used by an organization, users may create new resource groups. For example, users may create a sub-resource (e.g., citrus) under an existing resource (e.g., fruits) to view information of resource with finer granularity. The system may then update an interactive graph to include information (e.g., counts, conditions, or the like) of user-created resource. As such, the system can provide more customized views of information of resource.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality. LLMs can be useful for natural language processing, including receiving natural language prompts and providing natural language responses based on the text on which the model is trained. LLMs may not be data security-or data permissions-aware, however, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), GPT-4o, OpenAI o1, LLaMA (Large Language Model Meta AI), and BigScience Large Open-science Open-access Multilingual Language Model (BLOOM).

A Prompt (or “Natural Language Prompt” or “Model Input”) can be, for example, a term, phrase, question, and/or statement written in a human language (e.g., English, Chinese, Spanish, and/or the like), and/or other text string, that may serve as a starting point for a language model and/or other language processing. A prompt may include only a user input or may be generated based on a user input, such as by a prompt generation module (e.g., of a document search system) that supplements a user input with instructions, examples, and/or information that may improve the effectiveness (e.g., accuracy and/or relevance) of an output from the language model. A prompt may be provided to an LLM which the LLM can use to generate a response (or “model output”).

A User Operation (or “User Input”) can be any operations performed by one or more users to user interface(s) and/or other user input devices associated with a system (e.g., the data extraction system). User operation can include a request for task(s) to be performed, such as by using a machine learning model and/or an LLM, in whole or in part. User operation can include a request for data, such as data accessed and/or processed by one or more services. User operation can include one or more queries, one or more questions, one or more requests, or the like. User operation may include one or more natural language instructions for some data analysis (e.g., forecast, prediction, estimation, classification, or the like) to be performed. User operations can include, for example, select, drag, move, group, or the like, one or more interactive graphical representations for updating an ontology.

A Software Application (or “Application”) or a software-based workflow can be any computer-executable program or group of programs, scripts, routines, and/or the like, designed to perform specific tasks for users. The tasks performed can range from productivity functions, such as document processing, email management, and spreadsheet management, to entertainment, such as gaming and media playback, or other types of tasks. A software application may be built to run on various platforms, including desktop computers, mobile devices, servers, web browsers and/or the like, and they can interact with the underlying operating system to utilize hardware resources and provide a user interface for interaction. A software application may be developed using programming languages (e.g., JavaScript), tools and/or frameworks (e.g., Ontology Software Development Kit (OSDK)) that are suited to the target platform. A software application can be used to perform various actions (e.g., send or unsend an email, edit or update a document, or the like) on various data objects of data object types (e.g., a document data object, a log data object, an email data object, or the like).

An Ontology can include stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types. An ontology may be used by an organization to model a view of, or provide a template for, what objects exist in the world, what their properties are, and how they are related to each other.

A Data Object (or “Object” or “Data Object Instance”) is a data container for information representing a specific thing in the world that has a number of definable properties. For example, a data object can represent a machine learning model. A data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. A data object can represent an action (e.g., an action object for performing any task and/or any operation for fulfilling any objective), a function (e.g., a function object implemented by code for performing any task and/or any operation for fulfilling any objective), a logic (e.g., a logic object used to determine if any information is needed for performing certain task and/or operation), an automation (e.g., an automation object for automatically performing any task and/or any operation), and/or the like. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth. A data object may be of a data object type, where the data object is stored in a database that is associated with an ontology that defines the data object type.

A Data Object Type (or “Object Type”) is a type of a data object (e.g., person, event, document, and/or the like). Data object types may be defined by an ontology and may be modified or updated to include additional object types. A data object definition (e.g., in an ontology) may include how the data object is related to other data objects, such as being a sub-data object type of another data object type (e.g., an agent may be a sub-data object type of a person data object type), and the properties the data object type may have.

A Data Store is any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage). According to various implementations, any data storage, data stores, databases, and/or the like described in the present disclosure may, in various implementations, be replaced by appropriate alternative data storage, data stores, databases, and/or the like.

A Database is any data structure (and/or combinations of multiple data structures) for storing and/or organizing data, including, but not limited to, relational databases (e.g., Oracle databases, PostgreSQL databases, MySQL databases, and the like), non-relational databases (e.g., NoSQL databases, and the like), in-memory databases, spreadsheets, comma separated values (CSV) files, eXtensible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various implementations such data may be combined and/or separated in any appropriate way into one or more databases, one or more tables of one or more databases, and/or the like. According to various implementations, any database(s) described in the present disclosure may be replaced by appropriate data store(s). Further, data source(s) of the present disclosure may include one or more databases, one or more tables, one or more data sources, and/or the like, for example.

### Example System and Related Computing Environment

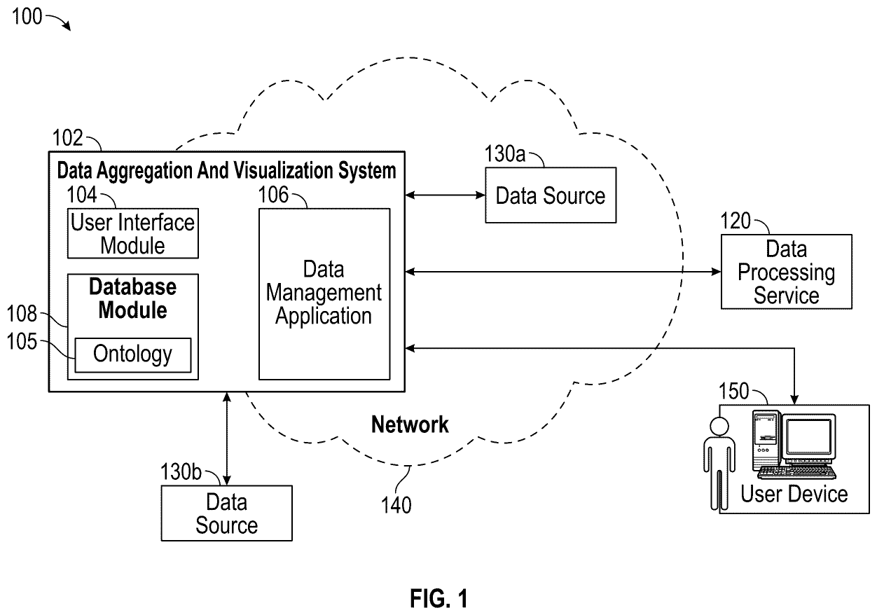

FIG. 1 illustrates an example computing environment 100 including an example data aggregation and visualization system 102 in communication with various devices to respond to a user input or a triggering event, according to various implementations of the present disclosure. The example computing environment 100 includes the data aggregation and visualization system 102, one or more data sources (e.g., data source 130a, and data source 130b), a network 140, a data processing service 120, and a user device 150 (and/or user computing device). In the example of FIG. 1, the data aggregation and visualization system 102 comprises various modules, including a user interface module 104, a data management application 106, and a database module 108 that includes an ontology 105. In other embodiments, the data aggregation and visualization system 102 may include fewer or additional components.

In the example of FIG. 1, the various devices are in communication via a network 140, which may include any combination of networks, such as one or more local area network (LAN), personal area network (PAN), wide area network (WAN), Global System for Mobile Communications (GSM) network, a Code Division Multiple Access (CDMA) network, a Long Term Evolution (LTE) network, the Internet, and/or any other communication network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. In various implementations, modules of the illustrated components, such as the user interface module 104, the data management application 106, and the database module 108 of the data aggregation and visualization system 102, may communicate via an internal bus and/or via the network 140. Additionally, the data aggregation and visualization system 102 may communicate with the one or more data sources (e.g., the data source 130a and the data source 130b) and the data processing service 120 via the network 140 in the course of fulfilling an objective (e.g., obtaining comprehensive views of resource counts and other related information associated with one or more resources used by entities of an organization) and/or a user input.

The data processing service 120 may include any quantity of services (or “plug-ins”) and any available type of service. For example, the data processing service 120 may include one or more software applications or services (e.g., a similarity search service, a table search service, an object search service, a text search service, or any other appropriate search service), indexing services, services for formatting text or visual graphics, services for generating, creating, embedding and/or managing interactive objects in a graphical user interface, services for caching data, services for writing to databases, an ontology traversing service (e.g., for traversing the ontology 105 or performing search-arounds in the ontology 105 to surface linked objects or other data items) or any other services. In some implementations, the data processing service 120 may be a part of the data aggregation and visualization system 102 (e.g., as part of a data processing service module of the data aggregation and visualization system 102), in whole or in part.

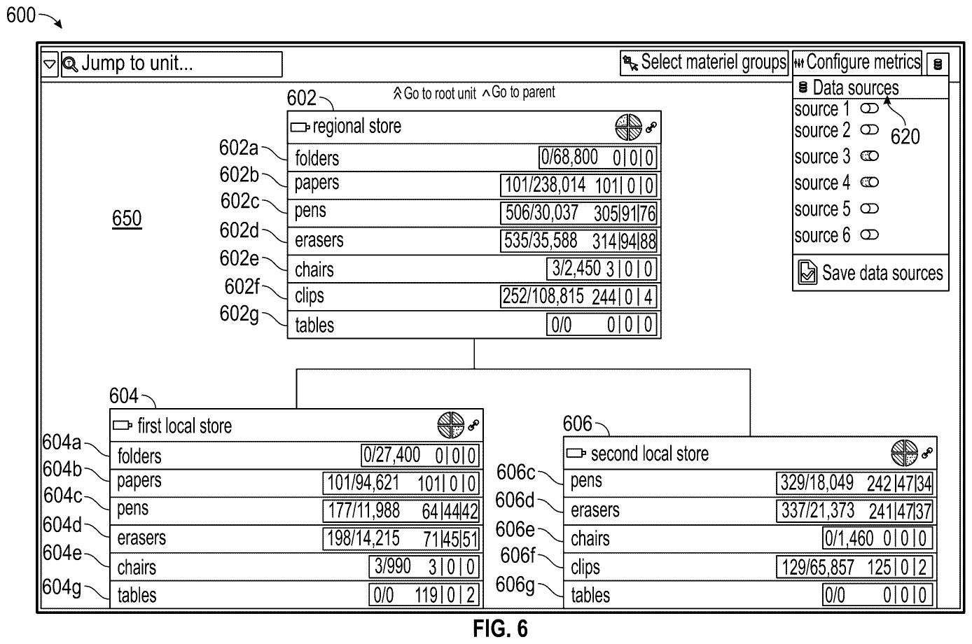

The user interface module 104 is configured to generate user interface data that may be rendered on a user device 150, such as to receive an initial user input, as well as later user input that may be used to initiate further data processing. In various implementations, the functionality discussed with reference to the user interface module 104, and/or any other user interface functionality discussed herein, may be performed by a device or service outside of the data aggregation and visualization system 102 and/or the user interface module 104 may be outside the data aggregation and visualization system 102. Example user interfaces that can be provided by the user interface module 104 (e.g., to the user device 150) will be described with reference to FIGS. 6, 7, 8, 9, and 10.

The database module 108 is configured to store data that may be accessed by the user device 150 and/or various aspects of the data aggregation and visualization system 102, as described herein. For example, the database module 108 is configured to store data/information that may be utilized by the data management application 106, the user interface module 104, and/or accessed or manipulated by the user device 150. The database module 108 of the data aggregation and visualization system 102 may obtain and store data and/or information from the data processing service 120. Data that may be stored by the database module 108 may include any type of electronic data, such as error logs, code files, documents, text, data files, books, manuals, emails, images, audio, video, databases, metadata, positional data (e.g., geo-coordinates), sensor data, web pages, time series data, and/or any combination of the foregoing and/or the like. The database module 108 may store the data using the ontology 105, or based on the ontology 105, which may define data types and associated properties, and relationships among data types, data object types, properties, and/or the like. The ontology 105 may constitute a way to represent things in the world. The ontology 105 may be used by an organization to model a view on what objects exist in the world, what their properties are, and how they are related to each other. The ontology 105 may be user-defined, computer-defined, or some combination of the two. The ontology 105 may include hierarchical relationships among data object types. The ontology 105 may define and/or store a data object of a data object type that includes hierarchy information of the organization.

As shown in FIG. 1, the data aggregation and visualization system 102 may be capable of interfacing with multiple data sources (e.g., the data source 130a, the data source 130b, and/or other data sources not shown in FIG. 1). The data source 130a and the data source 130b may store at least data including information about resources used by an organization associated with the user device 150. Data including information about resources received from the data source 130a and/or data source 130b may include any type of electronic data, such as text, files, documents, books, manuals, emails, images, audio, video, databases, metadata, positional data (e.g., geo-coordinates), sensor data, web pages, time series data, and/or any combination of the foregoing and/or the like. In some examples, information about resources may be stored in the data source 130a and/or data source 130b in the form of a spreadsheet, a table, a list, and/or any other formats.

In some examples, the data aggregation and visualization system 102 can access the data source 130a and/or data source 130b to receive information (e.g., name, quantity, condition, place of storage, and/or the like) about resources (e.g., raw material, medical equipment, manpower, and/or the like) that may be used by or associated with entities (e.g., units, personnels, divisions, departments) across a hierarchy of an organization associated with the user device 150. The data aggregation and visualization system 102 may automatically aggregate information about resources from the data source 130a and/or data source 130b to generate accurate and up-to-date information of resource used by the organization.

For example, the data management application 106 can access the data source 130a and/or data source 130b to receive information (e.g., names, quantities, amount, conditions, and/or the like) about resources (e.g., material, equipment, manpower, and/or the like) used by or associated with entities (e.g., units, personnels, divisions, departments, teams) across a hierarchy of an organization. Based on information about resources and hierarchy information (e.g., information stored in the database module 108 indicating that a unit has a higher authority or is in a higher hierarchical level than another unit) of the organization, the data management application 106 can determine quantity information of a resource associated with entities in a lower hierarchical level.

In some examples, the data management application 106 can further automatically aggregate the quantity information of the resource associated with entities in the lower hierarchical level to determine quantity information of entities that are in a higher hierarchical level. Based on hierarchy information and aforementioned quantity information, the data management application 106 can generate an interactive graph comprising nodes (e.g., representing entities) and edges (e.g., representing connections between entities) to indicate or present quantity and other information (e.g., trends, forecasts, conditions, and/or the like of resources) about the resource across the hierarchy of the organization. The data management application 106 can provide the interactive graph through the user interface module 104 to the user device 150. In some examples, the data management application 106 can be embodied as a software application that interacts with the ontology 105, the data processing service 120, the user interface module 104, and/or the data sources 130a and 130b through certain software protocols, interfaces, and/or frameworks (e.g., APIs, OSDK, and/or the like)

### Example System and Related Modules

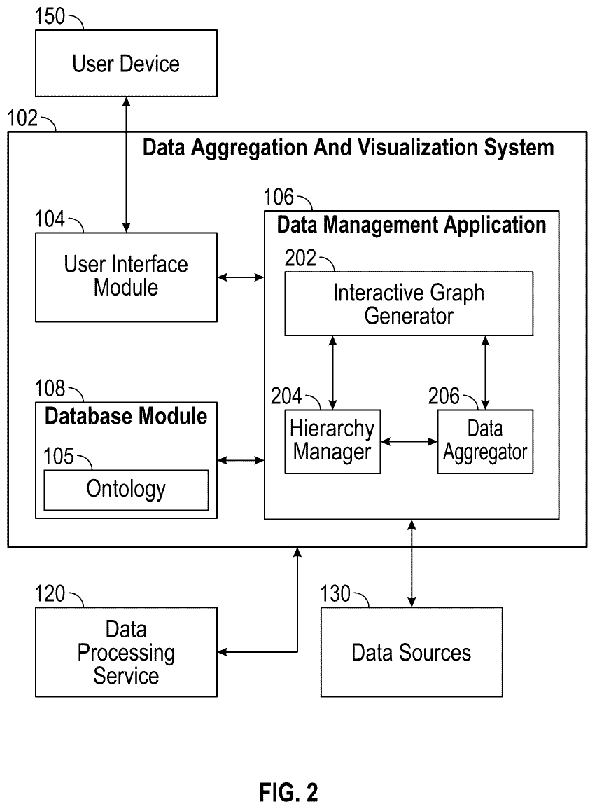

FIG. 2 depicts example connections and/or communications between various modules of the data aggregation and visualization system 102, including the user interface module 104, the data management application 106, and the database module 108. In other embodiments, the data aggregation and visualization system 102 may include fewer or additional connections/communications. The indicated connections and/or data flows of FIG. 2 are exemplary of only certain processes performed by the data aggregation and visualization system 102 and are not meant to include all possible blocks and participants.

As shown in FIG. 2, the data management application 106 can include at least a data aggregator 206, a hierarchy manager 204, an interactive graph generator 202. In some examples, the data aggregator 206 can coordinate with the hierarchy manager 204 and the interactive graph generator 202 to automatically aggregate data for providing the user device 150 with real-time and comprehensive views of resource counts and other resource related information, thereby enabling the user device 150 to effectively manage resources (e.g., dispatch, track, query, procure, and/or the like).

For example, the data aggregator 206 can access data sources 130 to receive data including information about resources used by an organization associated with the user device 150. As noted above, data including information about resources received from data sources may include any type of electronic data, such as text, files, documents, books, manuals, emails, images, audio, video, databases, metadata, positional data (e.g., geo-coordinates), sensor data, web pages, time series data, and/or any combination of the foregoing and/or the like. Information about resources may be stored in the form of a spreadsheet, a table, a list, and/or any other formats. The data aggregator 206 can access data from data sources 130 to receive information (e.g., name, quantity, condition, place of storage, and/or the like) about resources (e.g., raw material, medical equipment, manpower, and/or the like) that may be used by or associated with entities (e.g., units, personnels, divisions, departments) across a hierarchy of the organization. The data aggregator 206 may automatically aggregate information about resources from multiple data sources to generate accurate and up-to-date information of resource.

In some examples, the data aggregator 206 may continually monitor updates to data sources 130 accessed by the system. For example, through an application programming interface (API) or other software tools and services (e.g., services provided by the data processing service 120) for interacting with data storage systems associated with the data sources 130, the data aggregator 206 may periodically monitor any update to data sources 130. When an update to a data source 130 is detected, the data aggregator 206 can automatically access updated information and generate updated resource counts by aggregating at least updated information.

The data aggregator 206 can also detect if there is any conflict of resource information received from various data sources 130. For example, the system can detect that quantity information about a medical equipment received from a first data source is different from that received from a second data source. In this example, the system can choose to use quantity information from the data source that was most recently updated. Alternatively, the system can choose one data source over another (e.g., the first data source) if there is any indication (e.g., based on user reviews, past aggregation statistics) that the first data source is more trustworthy than the second data source.

The hierarchy manager 204 can access hierarchy information indicative of a hierarchy of an organization. The hierarchy information can be used to determine the relationships between different entities in the hierarchy of the organization, such as which entities are at a lower level and which are at a higher level within the hierarchy. In some examples, the hierarchy information can be represented using any data structure or structured format (e.g., using data models or schemas that define the entities and their hierarchical relationships, or using other data storage formats such as JavaScript Object Notation (“JSON”)) that enables the hierarchy manager 204 to analyze and determine relationships between entities. In some examples, the hierarchy information can be stored as a data object in the ontology 105. The hierarchy manager 204 may access the data object in the ontology 105, and parse or traverse the hierarchy information to determine, for example, relationships between entities of an organization.

In some examples, the hierarchy manager 204 may optionally utilize machine learning models (e.g., large language models (LLMs)) to parse or traverse hierarchy information of an organization that may have complex hierarchical structures. Based on the hierarchy information, the hierarchy manager 204, the data aggregator 206, and/or the link 302 can perform various operations, such as aggregating resource quantities across different levels of the hierarchy or generating interactive graphs that visually represent the hierarchy and associated data to enable user(s) of the user device 150 to view, analyze, or otherwise manage aggregated statistics and trends across the organizational hierarchy.

For example, based on hierarchy information indicative of a hierarchy of an organization, the hierarchy manager 204 can determine that a first entity (e.g., a functional team) and a second entity (e.g., a design team) are in a lower level of the hierarchy and a third entity (e.g., a corporate unit) is in a higher level of the hierarchy. The data aggregator 206 can further aggregate resource information associated with the first entity and the second entity to determine resource information associated with the third entity. For example, based on resource information received from various data sources, the data aggregator 206 can determine that the first entity is associated with a first quantity or amount of a raw material (e.g., the first entity has in its possession 300 kilograms of copper, but has a need of 600 kilograms of copper), and that the second entity is associated with a second quantity or amount of a raw material (e.g., the second entity has in its possession 150 kilograms of copper, but has a need of 300 kilograms of copper). Based on the first quantity and the second quantity, the data aggregator 206 can determine that the third entity is associated with a third quantity or amount of the raw material. For example, by aggregating the first quantity and the second quantity, the data aggregator 206 can automatically determine that the third entity has under its disposal 450 kilograms of copper but has a need of 900 kilograms of copper.

Based on the hierarchy information processed by the hierarchy manager 204, the quantities or amounts of resources associated with entities across a hierarchy of an organization aggregated by the data aggregator 206, the link 302 can generate an interactive graph representing the hierarchy and comprising nodes and/or edges to represent the entities of the organization along with hierarchical relationships among the entities. By performing various operations (e.g., select, drag, move, group, or the like) on the nodes or edges of the interactive graph and/or other user interface elements of a user interface that presents the interactive graph, user(s) of the user device 150 associated with the organization may customize their interactions with the data aggregation and visualization system 102 to focus on various aspects of resource information based on their objectives and/or roles in the hierarchy of the organization.

Advantageously, the data aggregation and visualization system 102 may enable user(s) of the user device 150 associated with an organization having complex hierarchical structures (e.g., many levels and/or branches) to view through an integrated computer environment (e.g., a web-based interface) aggregated statistics, trends, forecasts, conditions about resources that are used by entities across a hierarchical organizational structure. By accessing and integrating information about resources from multiple data sources, the data aggregation and visualization system 102 can also offer real-time insights about resources (e.g., supply metrics, demand information). As such, the data aggregation and visualization system 102 can enable the user device 150 associated with the organization to access most current data for making informed decisions or taking timely actions (e.g., adjusting resource allocations). Additionally, the data aggregation and visualization system 102 can enable user(s) of the user device 150 to create custom views of their organization hierarchies, allowing them to generate counts, trends, alerts, and/or the like regarding the availability and event history of resources used across different levels of the organization's hierarchy. For example, the user device 150 may organize units of an organization in a different hierarchy than an organizational standard, or may leave out certain units to aggregate and visualize data associated with certain units and/or sub-units of a unit that the user is interested in or authorized to access. Based on a hierarchy organized or defined by the user, the data aggregation and visualization system 102 can automatically aggregate data based on the hierarchy and generate customized views showing information of resources to the user device 150.

Through the user interface module 104, the data aggregation and visualization system 102 can further advantageously allow user(s) of the user device 150 to configure settings or metrics related to data sources, statistics, resources, and/or the like, and to view individual entity nodes within the organization's hierarchy for managing resources relevant to the users' operations. Besides automatically accessing resource information from data sources 130, the data aggregation and visualization system 102 can provide a submission portal through the user interface module 104 for the user device 150 to update resource counts (e.g., supply counts, demand counts) using files storing resource information. The data aggregation and visualization system 102 can also enable user(s) of the user device 150 to manually overwrite information about resources (e.g., manually update quantity of a resource through interacting with the user interface module 104) and/or toggle different data sources 130 on and off, allowing the user(s) of the user device 150 to customize their operating picture based on preferred sources of truth.

### Example Database and Data Models

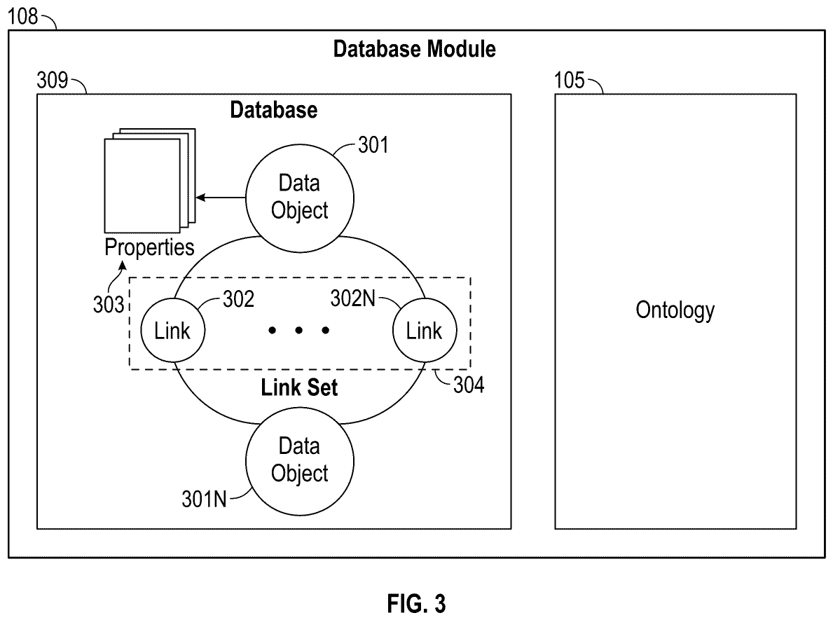

FIG. 3 illustrates an object-centric conceptual data model in the database module 108 of the data aggregation and visualization system 102 according to various implementations of the present disclosure. The database module 108 may store the ontology 105 and the database 309. The ontology 105, as noted above, may include stored information providing a data model for storage of data in the database 309. The ontology 105 may be defined by one or more data object types, which may each be associated with one or more property types. At the highest level of abstraction, data object 301 is a container for information representing things in the world. For example, the data object 301 can represent an entity such as a particular person, a hierarchy of an organization, place, organization, date, market instrument, item, or other noun, where the entity may appear in text data such as a document, an e-mail message, a news report, a written paper, an article, or the like. Data object 301 can also represent an event that happens at a point in time or for a duration. Each data object 301 may be associated with a unique identifier that uniquely identifies the data object within the database 309 of the database module 108.

In various implementations, different types of data objects may have different property types. For example, a “Person” data object might have an “Eye Color” property type and an “Event” data object might have a “Date” property type. Each property 303 as represented by data in the database module 108 may have a property type defined by the ontology 105 used by the database module 108. Objects may be instantiated in the database 309 in accordance with the corresponding object definition for the particular object in the ontology 105. For example, a specific monetary payment (e.g., an object of type “event”) of US$30.00 (e.g., a property of type “currency”) taking place on Mar. 27, 2009 (e.g., a property of type “date”) may be stored in the database 309 as an event object with associated currency and date properties as defined within the ontology 105. The data objects defined in the ontology 105 may support property multiplicity. In particular, the data object 301 may be allowed to have more than one property 303 of the same property type. For example, a “Person” data object might have multiple “Address” properties or multiple “Name” properties. Each link 302 represents a connection between two data objects 301. In one implementation, the connection is either through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event connection, two “Person” data objects may be connected by an “Airline Flight” data object representing a particular airline flight if they traveled together on that flight, or by a “Meeting” data object representing a particular meeting if they both attended that meeting. In one implementation, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In one implementation, a link between two data objects may be established based on similar or matching properties (e.g., property types and/or property values) of the data objects. These are just various examples of the types of connections that may be represented by a link and other types of connections may be represented; implementations are not limited to any particular types of connections between data objects. For example, a document might contain references to two different objects. For example, a document may contain a reference to a payment (one object), and a person (a second object). A link between these two objects may represent a connection between these two entities through their co-occurrence within the same document. Each data object 301 can have multiple links with another data object 301 to form a link set 304. For example, two “Person” data objects representing a husband and a wife could be linked through a “Spouse Of” relationship, a matching “Address” property, and one or more matching “Event” properties (e.g., a wedding). Each link 302 as represented by data in the database 309 may have a link type defined by the ontology 105 and/or used by the database 309.

For ease of understanding, in some implementations, data objects (e.g., the data object 301 and the data object 301N), links between data objects (e.g., the link 302 and link 302N) that may represent relationships between the data objects, and properties of data objects (e.g., the properties 303) can be visualized using one or more graphical user interfaces (GUI). For example, an example user interface may show a graphical representation of relationships between data objects that are represented as nodes in the graphical representation. The data objects may include, for example, person data objects, flight data objects, account data objects, computer data objects, and/or the like. The objects/nodes may have relationships and/or links with any of the other objects/nodes.

In some implementations, relationships between data objects may be stored as links, or in some implementations, as properties, where a relationship may be detected between the properties. In some cases, as stated above, the links may be directional. For example, a payment link may have a direction associated with the payment, where one person object is a receiver of a payment, and another person object is the payer of payment.

In addition to visually showing relationships between the data objects, a user interface may allow various other manipulations. For example, the objects within database module 108 may be searched using a search interface (e.g., text string matching of object properties), inspected (e.g., properties and associated data viewed), filtered (e.g., narrowing the universe of objects into sets and subsets by properties or relationships), and statistically aggregated (e.g., numerically summarized based on summarization criteria), among other operations and visualizations.

### Example Functionality and Operations of the System

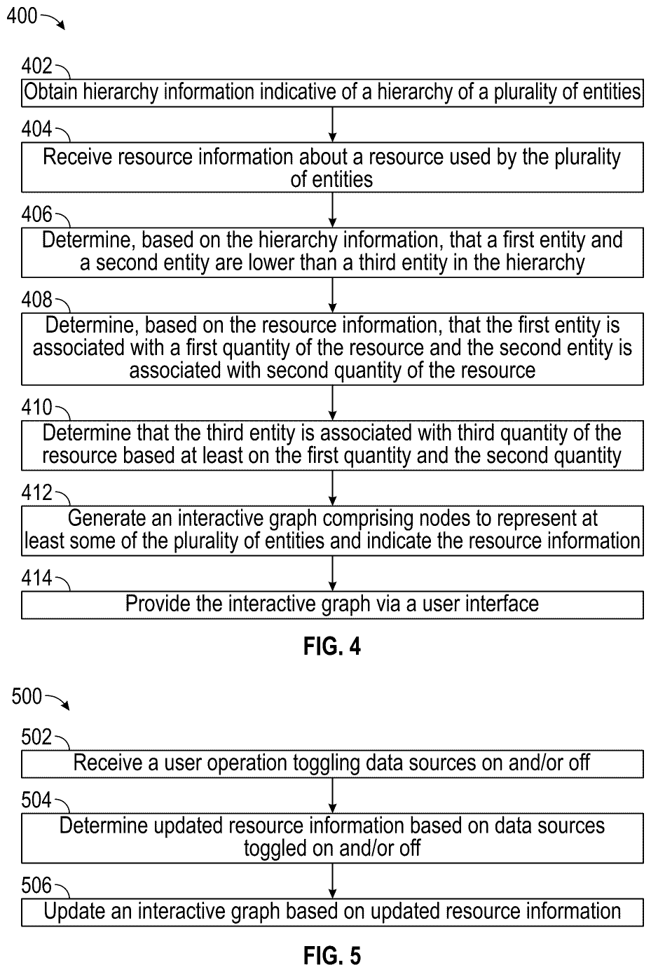

FIGS. 4 and 5 show flowcharts illustrating example operations of the data aggregation and visualization system 102 (and/or various other aspects of the example computing environment 100), according to various embodiments. The blocks of the flowcharts illustrate example implementations, and in various other implementations various blocks may be rearranged, optional, and/or omitted, and/or additional block may be added. In various embodiments, the example operations associated with the flowcharts illustrated in FIGS. 4 and 5 may be implemented, for example, by the one or more aspects of the data aggregation and visualization system 102, various other aspects of the example computing environment 100, and/or the like.

FIG. 4 depicts a flowchart illustrating an example method 400 according to various embodiments. The method 400 may be implemented, for example, by the data aggregation and visualization system 102 of FIGS. 1 and 2 to automatically aggregate data for providing users with a comprehensive view of resource counts and other related information. In various implementations, the method 400 may be performed in part, in full, and/or in various orders by the data aggregation and visualization system 102. For example, some of the blocks of the method 400 may be changed in order, performed concurrently, and/or omitted. The method 400 may be performed by the data aggregation and visualization system 102 to generate example interactive graphical visualizations described with reference to FIGS. 6, 7, 8, 9, and/or 10.

At block 402, the data aggregation and visualization system 102 may obtain hierarchy information indicative of a hierarchy of a plurality of entities in an organization. In some examples, the hierarchy manager 204 can access hierarchy information indicative of a hierarchy of an organization. As noted above, the hierarchy information can be represented using any data structure or structured format (e.g., using data models or schemas that define the entities and their hierarchical relationships, or using other data storage formats such as JavaScript Object Notation (“JSON”)) that enables the hierarchy manager 204 to analyze and determine relationships between entities. For example, the hierarchy information can be stored as a data object (e.g., the data object 301) in the ontology 105 associated with the data aggregation and visualization system 102. The hierarchy information can indicate that the organization includes at least a first entity, a second entity, and a third entity in its hierarchy.

At block 404, the data aggregation and visualization system 102 may receive resource information about one or more resources used by the plurality of entities of the organization. In some examples, the data aggregator 206 receives resource information about one or more resources used by the plurality of entities of the organization. For example, the data aggregator 206 can receive from the data source 130a first quantity information of a first resource used by the plurality of entities. The data aggregator 206 can receive, from the data source 130b, second quantity information of the first resource used by the plurality of entities. As noted above, information about resources received from at least data sources 130a and 130b may include any type of electronic data, such as text, files, documents, books, manuals, emails, images, audio, video, databases, metadata, positional data (e.g., geo-coordinates), sensor data, web pages, time series data, and/or any combination of the foregoing and/or the like. In some examples, information about resources may be stored in the form of a spreadsheet, a table, a list, and/or any other formats. Besides obtaining quantity information, the data aggregator 206 can access at least data sources 130a and 130b to receive other information (e.g., name, condition, place of storage, and/or the like) about resources (e.g., raw material, medical equipment, manpower, and/or the like) that may be used by or associated with entities (e.g., units, personnels, divisions, departments) across a hierarchy of an organization.

At block 406, the data aggregation and visualization system 102 can determine hierarchical relationships (e.g., a first entity and a second entity are lower than a third entity in a hierarchy of an organization) of the plurality of entities of the organization based on the hierarchy information. In some examples, the hierarchy manager 204 can use the hierarchy information stored in the data object 301 to determine the relationships between different entities in the hierarchy of the organization, such as which entities are at a lower level and which are at a higher level within the hierarchy. More specifically, the hierarchy manager 204 may access the data object 301 in the ontology 105, and parse or traverse the hierarchy information to determine, for example, relationships between entities of an organization. In some examples, the hierarchy manager 204 may optionally utilize machine learning models (e.g., large language models (LLMs)) to parse or traverse hierarchy information of an organization that may have complex hierarchical structures. For example, based on hierarchy information indicative of a hierarchy of an organization, the hierarchy manager 204 can determine that a first entity (e.g., a functional team) and a second entity (e.g., a design team) are in a lower level of the hierarchy and a third entity (e.g., a corporate unit) is in a higher level of the hierarchy.

At block 408, the data aggregation and visualization system 102 can determine quantity information of resources used by entities in a lower hierarchy of an organization. For example, the data aggregator 206 can determine, based on the resource information received at least from the data source 130a and the data source 130b, that the first entity is associated with a first quantity of the first resource and the second entity is associated with second quantity of the first resource. More specifically, based on the first quantity information of the first resource received from the data source 130a and the second quantity information of the first resource received from the data source 130b, the data aggregator 206 can determine that the first entity is associated with a first quantity or amount of a raw material (e.g., the first entity has in its possession 300 kilograms of copper, but has a need of 600 kilograms of copper). Based on the first quantity information of the first resource received from the data source 130a and the second quantity information of the first resource received from the data source 130b, the data aggregator 206 can determine that the second entity is associated with a second quantity or amount of a raw material (e.g., the second entity has in its possession 150 kilograms of copper, but has a need of 300 kilograms of copper).

In some examples, the data aggregator 206 can detect if there is any conflict of resource information received from various data sources. For example, the data aggregator 206 can detect that the first quantity information about the first resource (e.g., a medical equipment) received from the data source 130a is contradictory to the second quantity information about the first resource received from the second data source 130b (e.g., the second quantity information shows that the first entity is associated a larger quantity of the first resource, compared with the first quantity information). In this example, the data aggregator 206 can choose to use the first quantity information from the data source 130a if the data source 130a was more recently updated than the data source 130b. Alternatively, the data aggregator 206 can choose the data source 130b over the data source 130a if there is any indication (e.g., based on user reviews from the user device 150, past aggregation statistics stored in the database module 108) that the data source 130b is more trustworthy than the data source 130a.

At block 410, the data aggregation and visualization system 102 can determine resource information (e.g., quantity information) associated with an entity at a higher hierarchy based on resource information associated with entities at a lower hierarchy. In some examples, the data aggregator 206 can determine that the third entity is associated with a third quantity of the first resource based at least on (i) the first quantity of the first resource associated with the first entity and (ii) the second quantity of the first resource associated with the second entity. For example, by aggregating the first quantity associated with the first entity (e.g., the first entity has in its possession 300 kilograms of copper, but has a need of 600 kilograms of copper) and the second quantity associated with the second entity (e.g., the second entity has in its possession 150 kilograms of copper, but has a need of 300 kilograms of copper), the data aggregator 206 can automatically determine that the third entity has under its disposal 450 kilograms of copper but has a need of 900 kilograms of copper.

At block 412, the data aggregation and visualization system 102 can generate an interactive graph comprising nodes to represent at least some of a plurality of entities in an organization and indicate the resource information. For example, based at least on the hierarchy information, the first quantity of the first resource, the second quantity of the first resource, and the third quantity of the first resource, the interactive graph generator 202 can generate an interactive graph representing the hierarchy of the organization. The interactive graph can include at least a first node representing the first entity, a second node representing the second entity, a third node representing the third entity, a user interface element of the first node, a user interface element of the second node, and a user interface of the third node. The user interface element of the first node can indicate that the first entity is associated with the first quantity of the first resource (e.g., the first entity has in its possession 300 kilograms of copper, but has a need of 600 kilograms of copper). The user interface element of the second node can indicate that the second entity is associated with the second quantity of the first resource (e.g., the second entity has in its possession 150 kilograms of copper, but has a need of 300 kilograms of copper). The user interface element of the third node can indicate that the third entity is associated with the third quantity of the first resource (e.g., the third entity has under its disposal 450 kilograms of copper but has a need of 900 kilograms of copper).

At block 414, the data aggregation and visualization system 102 can provide the interactive graph via a user interface. For example, the user interface module 104 can provide, through a user interface that will be described with reference to FIGS. 6, 7, 8, 9, and/or 10, the interactive graph. By performing various operations (e.g., select, drag, move, group, or the like) on the nodes or edges of the interactive graph and/or other user interface elements of the user interface that presents the interactive graph, user(s) of the user device 150 associated with the organization may advantageously customize their interactions with the system to focus on various aspects of resource information based on their objectives and/or roles in the hierarchy of the organization.

FIG. 5 is a flowchart illustrating an example method 500 for customizing user views of aggregated information about resources used by entities of an organization based on preferred data source(s). The method 500 may be implemented, for example, by the data aggregation and visualization system 102 (e.g., the data management application 106 and/or the user interface module 104) of FIGS. 1 and 2. In some implementations, the method 500 may be performed after block 414 of FIG. 4. For example, the method 500 may be performed by the data aggregation and visualization system 102 to aggregate resource information from data sources (e.g., the data source 130a and the data source 130b) preferred by user(s) of the user device 150.

At block 502, the data aggregation and visualization system 102 may receive a user operation toggling data sources on and/or off. For example, through a user interface, the user interface module 104 may receive a user operation on a first user interface element of the user interface and a second user interface element of the user interface. The first user interface element can represent and/or be indicative of the data source 130a, and the second user interface element can represent and/or be indicative of the data source 130b. The user operation can include a selection of the first user interface element and a deselection of the second user interface element (e.g., toggling the data source 130a to be on and toggling the data source 130b to be off).

At block 504, the data aggregation and visualization system 102 may determine updated resource information based on data sources toggled on and/or off. For example, prior to the user operation, the data aggregator 206 may determine resource information (e.g., quantity information) associated with the first resource based on both resource information received from the data source 130a and the data source 130b. In response to the user operation, the data aggregator 206 may instead determine the resource information associated with the first resource based on the first quantity information rather than the second quantity information. For example, based on the first quantity information rather than the second quantity information, the data aggregator 206 may determine that (i) the first entity is associated with a first updated quantity of the first resource and (ii) the second entity is associated with a second updated quantity of the first resource. Based at least on the first updated quantity and the second updated quantity, the data aggregator 206 may further determine that the third entity is associated with a third updated quantity of the first resource.

At block 506, the data aggregation and visualization system 102 may update an interactive graph based on updated resource information. For example, the interactive graph generator 202 may update the interactive graph generated at block 412 based on updated resource information obtained at block 504. More specifically, the interactive graph generator 202 may update (i) the user interface element of the first node to indicate that the first entity is associated with the first updated quantity of the first resource, (ii) the user interface element of the second node to indicate that the second entity is associated with the second updated quantity of the first resource, and (iii) the user interface element of the third node to indicate that the third entity is associated with the third updated quantity of the first resource.

### Example User Interfaces and Related Functionality

FIGS. 6-10 show example user interfaces that illustrate example interactive graphical visualizations representing resources used by entities across a hierarchy of an organization. The interactive user interface may allow user(s) of the user device 150 to make selections on nodes, edges, and/or user interface elements within the interactive graphical visualization for obtaining and/or aggregating information of resources from sources selected by the user(s). The example user interfaces may be presented through the user interface module 104 of the data aggregation and visualization system 102 of FIGS. 1-2 and/or a user interface of the user device 150. Advantageously, the example user interfaces can allow the user device 150 and/or the data aggregation and visualization system 102 to more efficiently aggregate statistics, trends, forecasts, conditions about resources that are used by entities across a hierarchical organizational structure.

As shown in FIG. 6, an example user interface 600 may include an interactive graph 650 that includes at least a node 602, a node 604, and a node 606. In some examples, the interactive graph 650 can be generated by the data aggregation and visualization system 102 (e.g., the data management application 106) based on the method 400. For example, the hierarchy manager 204, the data aggregator 206, and/or the interactive graph generator 202 may perform blocks of the method 400 to generate the interactive graph 650.

In some examples, the node 602 may represent a regional store of an organization (e.g., a school supply corporation). The node 604 may represent a first local store of the organization. The node 606 may represent a second local store of the organization. As indicated in the interactive graph 650, the regional store represented by the node 602 is in a higher level of a hierarchy (e.g., can supervise or control use of resources associated with entities in a lower level) of the organization, and the first local store represented by the node 604 and the second local store represented by the node 606 are in a lower level of the hierarchy of the organization. In some examples, hierarchy information indicative of the hierarchy of the organization can be stored using a data object (e.g., the data object 301) in the database module 108. For example, the hierarchy manager 204 can use the hierarchy information stored in the data object 301 to determine that the regional store is in a higher level of the hierarchy and the first local store and the second local store are in a lower level of the hierarchy. Here, the node 602 shows “regional store.” The node 604 shows “first local store.” The node 606 shows “second local store.”

As shown in the interactive graph 650, the node 602 includes at least a user interface element 602a, a user interface element 602b, a user interface element 602c, a user interface element 602d, a user interface element 602e, a user interface element 602f, and a user interface element 602g. The node 604 includes at least a user interface element 604a, a user interface element 604b, a user interface element 604c, a user interface element 604d, a user interface element 604e, and a user interface element 604g. The node 606 includes at least a user interface element 606c, a user interface element 606d, a user interface element 606e, a user interface element 606f, and a user interface element 606g.

Here, the user interface element 604a reads “folders,” with a corresponding pair of numbers “0/27,400” to indicate that the first local store represented by the node 604 is in possession of 0 folder and has a need (e.g., to satisfy customer requests) of 27,400 folders. The user interface element 604b reads “papers,” with a corresponding pair of numbers “101/94,621” to indicate that the first local store represented by the node 604 is in possession of 101 papers and has a need of 94,621 folders. The user interface element 604c reads “pens,” with a corresponding pair of numbers “177/11,988” to indicate that the first local store represented by the node 604 is in possession of 177 pens and has a need of 11,988 pens. The user interface element 604d reads “erasers,” with a corresponding pair of numbers “198/14,215” to indicate that the first local store represented by the node 604 is in possession of 198 erasers and has a need of 14,215 erasers. The user interface element 604e reads “chairs,” with a corresponding pair of numbers “3/990” to indicate that the first local store represented by the node 604 is in possession of 3 chairs and has a need of 990 chairs. The user interface element 604g reads “tables,” with a corresponding pair of numbers “0/0” to indicate that the first local store represented by the node 604 is in possession of 0 tables and has a need of 0 tables.

The user interface element 606c reads “pens,” with a corresponding pair of numbers “329/18,049” to indicate that the second local store represented by the node 606 is in possession of 329 pens and has a need of 18,049 pens. The user interface element 606d reads “erasers,” with a corresponding pair of numbers “337/21,373” to indicate that the second local store represented by the node 606 is in possession of 337 erasers and has a need of 21,373 erasers. The user interface element 606e reads “chairs,” with a corresponding pair of numbers “0/1,460” to indicate that the second local store represented by the node 606 is in possession of 0 chairs and has a need of 1,460 chairs. The user interface element 606f reads “clips,” with a corresponding pair of numbers “129/65,857” to indicate that the second local store represented by the node 606 is in possession of 129 clips and has a need of 65,857 clips. The user interface element 606g reads “tables,” with a corresponding pair of numbers “0/0” to indicate that the second local store represented by the node 606 is in possession of 0 tables and has a need of 0 tables.

The user interface element 602a reads “folders,” with a corresponding pair of numbers “0/68,800” to indicate that the regional store represented by the node 602 has control of 0 folder and is subject to a need of 68,800 folders. The user interface element 602b reads “papers,” with a corresponding pair of numbers “101/238,014” to indicate that the regional store represented by the node 602 has control of 101 papers and is subject to a need of 238,014 papers. The user interface element 602c reads “pens,” with a corresponding pair of numbers “506/30,037” to indicate that the regional store represented by the node 602 has control of 506 pens and is subject to a need of 30,037 pens. The user interface element 602d reads “erasers,” with a corresponding pair of numbers “535/35,588” to indicate that the regional store represented by the node 602 has a control of 535 erasers and is subject to a need of 35,588 erasers. The user interface element 602e reads “chairs,” with a corresponding pair of numbers “3/2,450” to indicate that the regional store represented by the node 602 has a control of 3 chairs and is subject to a need of 2,450 chairs. The user interface element 602g reads “tables,” with a corresponding pair of numbers “0/0” to indicate that the regional store represented by the node 602 has a control of 0 tables and is subject to a need of 0 tables.

As shown in FIG. 6, the user interface 600 also includes a display portion 620 that shows data sources based on which pairs of numbers associated with the node 602, the node 604, and the node 606 are generated. Here, the display portion 620 reads “Data sources.” Under the display portion 620 shows six data sources: “source 1,” “source 2,” “source 3,” “source 4,” “source 5,” and “source 6.” Here, the display portion 620 shows that “source 1,” “source 2,” “source 5,” and “source 6” are toggled to be off (e.g., are not used to generate the pairs of numbers shown in the interactive graph 650), and “source 3” and “source 4” are toggled to be on (e.g., the numbers shown in the interactive graph 650 are generated based on “source 3” and “source 4”).

In some examples, based on “source 3” (e.g., the data source 130a) and “source 4” (e.g., the data source 130b), the data management application 106 generates user interface elements of the node 604 and the node 606. The data management application 106 can determine numbers of the user interface elements of the node 602 based on numbers of the user interface elements of the node 604 and the node 606. For example, based on the pair of number (e.g., 177/11,988) in the user interface element 604c and the pair of number (e.g., 329/18,049) in the user interface element 606c, the data aggregator 206 can determine the pair of number (e.g., 506/30,037) in the user interface element 602c.

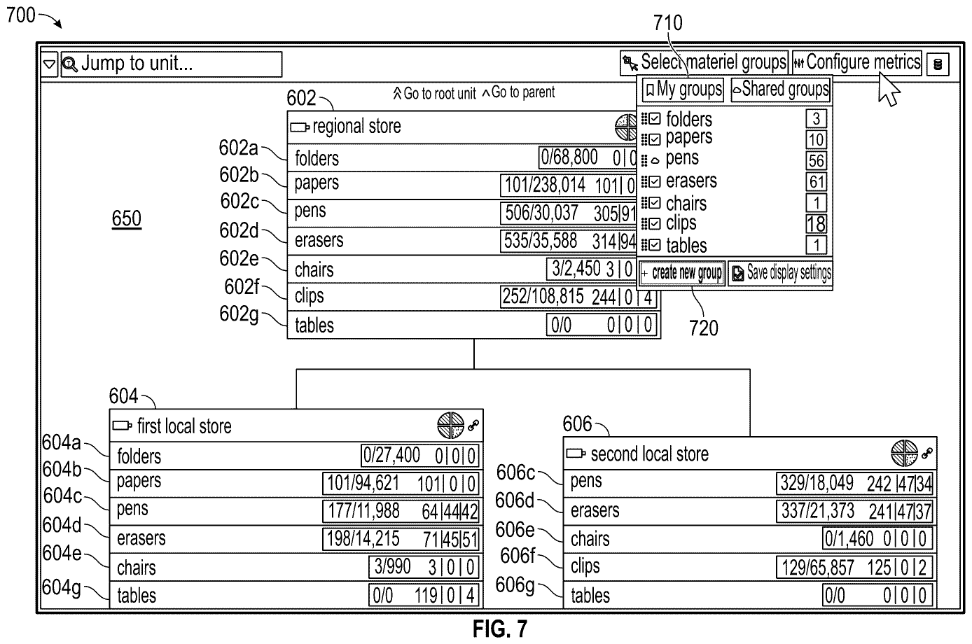

FIG. 7 shows an example user interface 700 that includes at least the interactive graph 650, a display portion 710, and a button 720, according to various implementations of the present disclosure. As noted above, the interactive graph 650 can include the node 602, the node 604, and the node 606 along with associated user interface elements to indicate information of resources (e.g., folders, papers, pens, erasers, and/or the like) used by entities of an organization. As shown in FIG. 7, the display portion 710 can enable user(s) of the user device 150 to define, create (e.g., create new resource groups), and/or otherwise update information of resources that are represented in the interactive graph 650.

Here, the display portion 710 shows “My group.” Under the display portion 710 includes various resources (e.g., folders, papers, pens, erasers, chairs, clips, and tables) that are represented by the interactive graph 650. The button 720 shows “Create new group,” indicating that the user device 150 can utilize the button 720 to create new resource groups not shown in the interactive graph 650. For example, using the button 720, user(s) of the user device 150 may create a sub-resource (e.g., A4 papers) under an existing resource (e.g., papers) to view information of resource with finer granularity. The data management application 106 may then update the interactive graph 650 to include information (e.g., counts, conditions, or the like) of user-created resources (e.g., A4 papers). As such, the data aggregation and visualization system 102 can provide more customized views of information of resources.

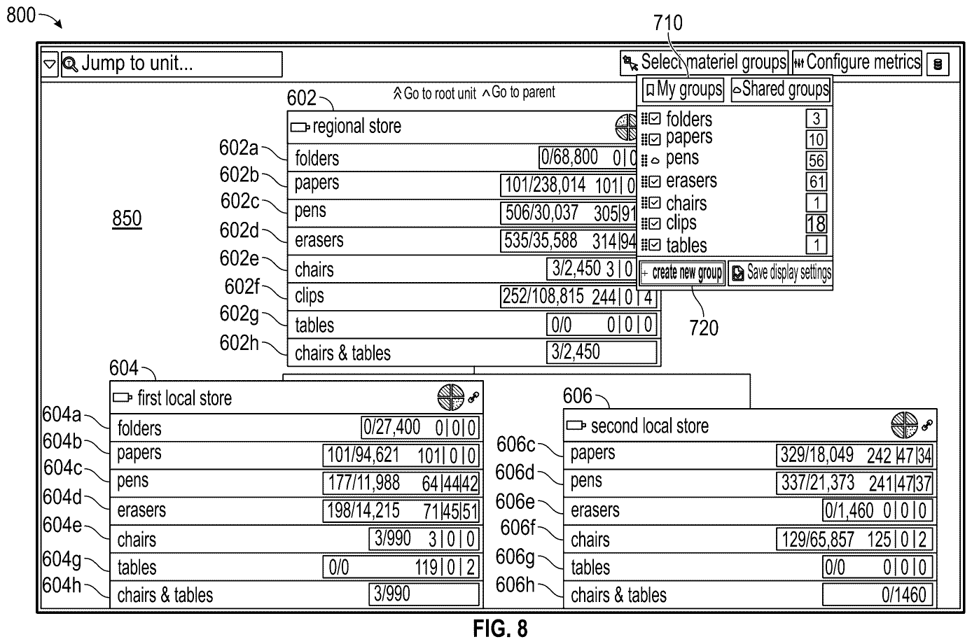

FIG. 8 shows an example user interface 800 that includes at least an interactive graph 850, according to various implementations of the present disclosure. In some examples, the interactive graph 850 can be updated based on the interactive graph 650 based on a user operation (e.g., clicking the button 720 and/or other manipulation on the user interface 700) indicating creation of a resource. More specifically, in contrast to the interactive graph 650, the interactive graph 850 can at least further include a user interface element 602h of the node 602, a user interface element 604h of the node 604, and a user interface element 606h of the node 606. Here, the user interface element 604h reads “chairs & tables,” with a corresponding pair of numbers “3/990.” The user interface element 606h reads “chairs & tables,” with a corresponding pair of numbers “0/1,460.” The user interface element 602h reads “chairs & tables,” with a corresponding pair of numbers “3/2,450.”

In some examples, the user interface element 604h, the user interface element 606h, and the user interface element 602h can be generated in response to a user operation (e.g., including at least clicking the button 720) indicating a union of “chairs” and “tables” to create a new resource group (“chairs & tables) that includes “chairs” and “tables.” In response to the user operation (e.g., received through the user interface module 104), the data aggregator 206 can determine that the first local store represented by the node 604 is in possession of 3 “chairs & tables” and has a need of 990 “chairs & tables” based on the pair of numbers “0/0” in the user interface element 604g and the pair of numbers “3/990” in the user interface element 604e. The data aggregator 206 can determine that the second local store represented by the node 606 is in possession of 0 “chairs & tables” and has a need of 1,460 “chairs & tables” based on the pair of numbers “0/0” in the user interface element 606g and the pair of numbers 0/1460” in the user interface element 606e. Based on the pair of number (e.g., “3/990”) in the user interface element 604h and the pair of number (e.g., 0/1,460) in the user interface element 606h, the data aggregator 206 can determine that the regional store represented by the node 602 has a control of or under its disposal 3 “chairs & tables” and has a need of 2,450 “chairs & tables.” The interactive graph generator 202 can further update the interactive graph 650 to generate the interactive graph 850 based on numbers associated with the resource “chairs & tables” determined by the data aggregator 206.

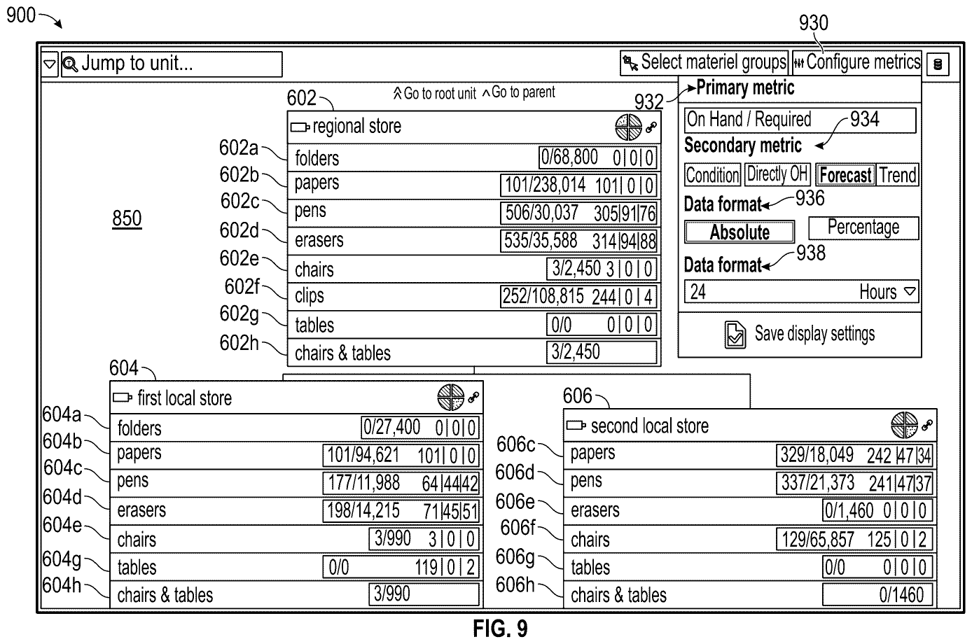

FIG. 9 shows an example user interface 900 that includes at least the interactive graph 850 and a display portion 930 that enables the user device 150 to configure settings and/or metrics related to data sources, statistics, trends, forecasts, conditions associated with resources used by entities of an organization associated with the user device 150. By configuring settings and/or metrics under the display portion 930, the user device 150 can obtain various information of resources generated by the data aggregation and visualization system 102.

Here, the display portion 930 reads “Configure metrics.” Under the display portion 930 includes a selection field 932, a selection field 934, selection field 936, and a selection field 938. The selection field 932 shows “Primary metric” and indicating that a selection “On Hand/Required” is selected. The selection field 934 shows “Secondary metric” and indicating that a selection “Forecast” is selected. The selection field 936 shows “Data format” and indicating that a selection “Absolute” is selected. The selection field 938 shows “Data format” and indicating that a selection “24 Hours” is selected.

In some examples, based on the selections associated with the selection field 932, the selection field 934, the selection field 936, and the selection field 938, the data aggregation and visualization system 102 can generate or update the interactive graph 850 to show forecast of resources (e.g., folders, papers, pens, erasers, chairs, clips, and tables) in the next 24 hours. In other examples, the user device 150 can select “Condition” under the selection field 934 to cause the data aggregation and visualization system 102 to generate or update the interactive graph 850 to show conditions (e.g., good condition, in repair, to be recycled) associated with resources.

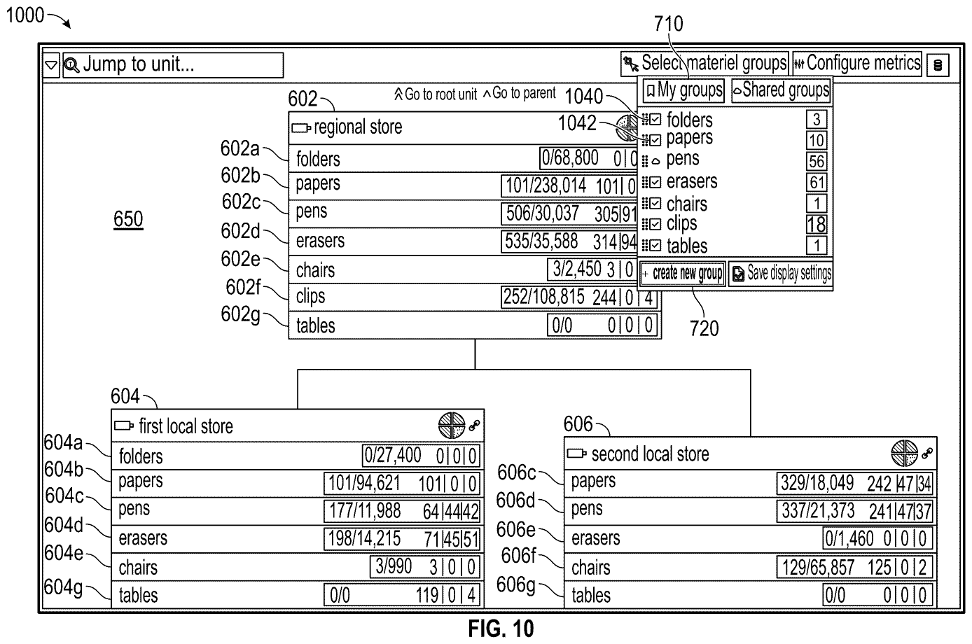

FIG. 10 shows an example user interface 1000 associated with the data aggregation and visualization system 102, according to various implementations of the present disclosure. The user interface 1000 can include at least the interactive graph 650 and the display portion 710. Under the display portion 710 includes at least a box 1040 and a box 1042. As shown in FIG. 10, the box 1040 is adjacent to the resource “folders.” The box 1042 is adjacent to the resource “papers.”

In some examples, by manipulating (e.g., mark and/or unmark) the box 1040 and the box 1042, a user of the user device 150 may conceal information about particular resources from being shown in the interactive graph 650. For example, by unmarking the box 1042, the data aggregation and visualization system 102 (e.g., the interactive graph generator 202) can update the interactive graph 650 to remove the user interface element 602b and the user interface element 604b from the interactive graph 650.

In other examples, the user device 150 can edit a hierarchy of an organization (e.g., through adding new nodes or removing the node 602, the node 604, and/or the node 606) to update the hierarchy in the user interface 1000 and/or in a separate user interface (e.g., provided by the user interface module 104) associated with the data aggregation and visualization system 102.

### Additional Example Implementations and Details

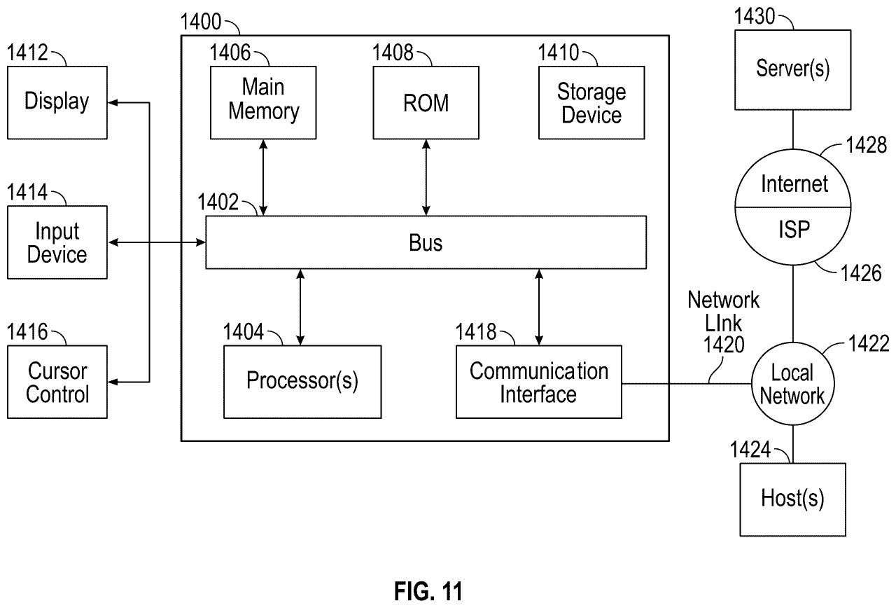

In an implementation of the system (e.g., one or more aspects of the data aggregation and visualization system 102, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 11) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In various implementations the virtual computing environment may comprise one or more virtual machines, containers, and/or other types of emulations of computing systems or environments. In various implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In various alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in various implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 11 shows a block diagram that illustrates a computer system 1400 upon which various implementations and/or aspects (e.g., one or more aspects of the computing environment 100, one or more aspects of the data aggregation and visualization system 102, one or more aspects of the user device 150, one or more aspects of the data processing service 120, one or more aspects of the data sources 130a and 130b, and/or the like) may be implemented. Multiple such computer systems 1400 may be used in various implementations of the present disclosure. Computer system 1400 includes a bus 1402 or other communication mechanism for communicating information, and a hardware processor, or multiple processors, 1004 coupled with bus 1402 for processing information. Hardware processor(s) 1404 may be, for example, one or more general purpose microprocessors.

Computer system 1400 also includes a main memory 1406, such as a random-access memory (RAM), cache and/or other dynamic storage devices, coupled to bus 1402 for storing information and instructions to be executed by processor 1404. Main memory 1406 also may be used for storing temporary variables or other intermediate information during execution of instructions to be executed by processor 1404. Such instructions, when stored in storage media accessible to processor 1404, render computer system 1400 into a special-purpose machine that is customized to perform the operations specified in the instructions. The main memory 1406 may, for example, include instructions to implement server instances, queuing modules, memory queues, storage queues, user interfaces, and/or other aspects of functionality of the present disclosure, according to various implementations.

Computer system 1400 further includes a read only memory (ROM) 1408 or other static storage device coupled to bus 1402 for storing static information and instructions for processor 1404. A storage device 1410, such as a magnetic disk, optical disk, or USB thumb drive (Flash drive), and/or the like, is provided and coupled to bus 1402 for storing information and instructions.

Computer system 1400 may be coupled via bus 1402 to a display 1412, such as a cathode ray tube (CRT) or LCD display (or touch screen), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 1400 may include a user interface module to implement a GUI that may be stored in a mass storage device as computer executable program instructions that are executed by the computing device(s). Computer system 1400 may further, as described below, implement the techniques described herein using customized hard-wired logic, one or more ASICs or FPGAs, firmware and/or program logic which in combination with the computer system causes or programs computer system 1400 to be a special-purpose machine. According to one implementation, the techniques herein are performed by computer system 1400 in response to processor(s) 1404 executing one or more sequences of one or more computer-readable program instructions contained in main memory 1406. Such instructions may be read into main memory 1406 from another storage medium, such as storage device 1410. Execution of the sequences of instructions contained in main memory 1406 causes processor(s) 1404 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN (or WAN component to communicated with a WAN). Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1026. ISP 1426 in turn provides data communication services through the worldwide packet data communication network now commonly referred to as the “Internet” 1028. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more non-transitory computer-readable storage devices storing software instructions executable by the computing system, the computerized method comprising:
accessing a data store that stores at least hierarchy information indicative of a hierarchy associated with a plurality of entities comprising a first entity, a second entity, and a third entity;
receiving, from a first data source, first quantity information of a first resource used by the plurality of entities;
receiving, from a second data source, second quantity information of the first resource used by the plurality of entities;
determining, based on the hierarchy information indicative of the hierarchy, that the first entity and the second entity are in a lower level of the hierarchy and the third entity is in a higher level of the hierarchy;
determining, based at least in part on the first quantity information of the first resource and the second quantity information of the first resource, that (i) the first entity is associated with a first quantity of the first resource and (ii) the second entity is associated with a second quantity of the first resource;
based at least on the first quantity of the first resource and the second quantity of the first resource, determining that the third entity is associated with a third quantity of the first resource;
based at least on the hierarchy information, the first quantity of the first resource, the second quantity of the first resource, and the third quantity of the first resource, generating an interactive graph representing the hierarchy and comprising a first node representing the first entity, a second node representing the second entity, a third node representing the third entity, a user interface element of the first node, a user interface element of the second node, and a user interface of the third node, wherein the user interface element of the first node indicates that the first entity is associated with the first quantity of the first resource, the user interface element of the second node indicates that the second entity is associated with the second quantity of the first resource, and the user interface element of the third node indicates that the third entity is associated with the third quantity of the first resource; and
providing, via a user interface, the interactive graph.

Clause 2. The computerized method of Clause 1, further comprising:
receiving a user operation, made via the user interface, on a first user interface element of the user interface and a second user interface element of the user interface, the first user interface element indicative of the first data source, the second user interface element indicative of the second data source, and the user operation comprising a selection of the first user interface element and a deselection of the second user interface element.

Clause 3. The computerized method of Clause 2, further comprising, in response to receiving the user operation:
determining, based on the first quantity information rather than the second quantity information, that (i) the first entity is associated with a first updated quantity of the first resource and (ii) the second entity is associated with a second updated quantity of the first resource;
based at least on the first updated quantity and the second updated quantity, determining that the third entity is associated with a third updated quantity of the first resource; and
updating (i) the user interface element of the first node to indicate that the first entity is associated with the first updated quantity of the first resource, (ii) the user interface element of the second node to indicate that the second entity is associated with the second updated quantity of the first resource, and (iii) the user interface element of the third node to indicate that the third entity is associated with the third updated quantity of the first resource.

Clause 4. The computerized method of Clause 1, wherein determining that (i) the first entity is associated with a first quantity of the first resource and (ii) the second entity is associated with a second quantity of the first resource comprises:
determining that the first quantity information conflicts with the second quantity information; and
in response to determining that the first quantity information conflicts with the second quantity information: using, based on a criterion, the first quantity information rather than the second quantity information to determine that (i) the first entity is associated with a first quantity of the first resource and (ii) the second entity is associated with a second quantity of the first resource.

Clause 5. The computerized method of Clause 4, wherein the criterion indicates that the first data source is more trustworthy than the second data source, or the first data source is more recently updated than the second data source.

Clause 6. The computerized method of Clause 1, wherein determining that the third entity is associated with the third quantity of the first resource comprises:
aggregating the first quantity and the second quantity to obtain the third quantity.

Clause 7. The computerized method of Clause 1, further comprising:
adding into one or more databases a first data object of a first data object type, the first data object representing the first entity;
adding into the one or more databases a second data object of a second data object type, the second data object representing the second entity; and
adding into the one or more databases a third data object of a third data object type, the third data object representing the third entity.

Clause 8. The computerized method of Clause 1, wherein the first entity represents a real-world department, division, team, unit, or personnel associated with an organization.

Clause 9. The computerized method of Clause 1, further comprising:
receiving, from the first data source, first quantity information of a second resource used by the plurality of entities;
receiving, from the second data source, second quantity information of the second resource used by the plurality of entities;
determining, based at least in part on the first quantity information of the second resource and the second quantity information of the second resource, that (i) the first entity is associated with a first quantity of the second resource and (ii) the second entity is associated with a second quantity of the second resource;
based at least on the first quantity of the second resource and the second quantity of the second resource, determining that the third entity is associated with a third quantity of the second resource; and
updating the interactive graph to include a second user interface element of the first node, a second user interface element of the second node, and a second user interface of the third node, wherein the second user interface element of the first node indicates that the first entity is associated with the first quantity of the second resource, the second user interface element of the second node indicates that the second entity is associated with the second quantity of the second resource, and the second user interface element of the third node indicates that the third entity is associated with the third quantity of the second resource.

Clause 10. The computerized method of Clause 9, further comprising:
receiving a user operation indicating a union of the first resource and the second resource to create a third resource comprising the first resource and the second resource; and
based at least in part on receiving the user operation:
   determining, based on the first quantity of the first resource and the first quantity of the second resource, that the first entity is associated with a first quantity of the third resource;
   determining, based on the second quantity of the first resource and the second quantity of the second resource, that the second entity is associated with a second quantity of the third resource;
   based at least on the first quantity of the third resource and the second quantity of the third resource, determining that the third entity is associated with a third quantity of the third resource; and
   updating the interactive graph to include a third user interface element of the first node, a third user interface element of the second node, and a third user interface of the third node, wherein the third user interface element of the first node indicates that the first entity is associated with the first quantity of the third resource, the third user interface element of the second node indicates that the second entity is associated with the second quantity of the third resource, and the third user interface element of the third node indicates that the third entity is associated with the third quantity of the third resource.

Clause 11. The computerized method of Clause 1, further comprising:
receiving a user operation indicating an overwrite of the first quantity of the first resource using an overwriting number; and
in response to receiving the user operation, updating the user interface element of the first node to indicate that the first entity is associated with the overwriting number of the first resource.

Clause 12. The computerized method of Clause 1, further comprising:
receiving a user operation, via the user interface, that configures one or more metrics for generating the interactive graph; and
in response to receiving the user operation, updating the interactive graph based on the one or more metrics.

Clause 13. The computerized method of Clause 12, wherein the one or more metrics comprise a condition, a forecast, a trend, or a period of time for the forecast associated with the first resource.

Clause 14. The computerized method of Clause 1, further comprising:
receiving a user operation, made via the user interface or another user interface, indicating a removal of the first entity from the hierarchy; and
in response to receiving the user operation, updating the interactive graph to at least remove the first node representing the first entity from the interactive graph.

Clause 15. The computerized method of Clause 1, wherein the hierarchy information is stored in a data object of a data object type defined in an ontology of a database module.

Clause 16. The computerized method of Clause 1, wherein the first resource comprises a material, a natural resource, an equipment, or a manpower.

Clause 17. A computerized method, performed by a computing system having one or more hardware computer processors and one or more non-transitory computer readable storage devices storing software instructions executable by the computing system, the computerized method comprising:
receiving, from at least a data source, quantity information of a resource used by a plurality of entities that comprise a first entity, a second entity, and a third entity;
determining, based on hierarchy information indicative of a hierarchy associated with the plurality of entities, that the first entity and the second entity are in a lower level of the hierarchy and the third entity is in a higher level of the hierarchy;
determining, based at least in part on the quantity information of the resource, that (i) the first entity is associated with a first quantity of the resource and (ii) the second entity is associated with a second quantity of the resource;
based at least in part on the first quantity and the second quantity, determining that the third entity is associated with a third quantity of the resource;
based at least in part on the hierarchy information and the third quantity, generating an interactive graph representing the hierarchy and comprising a first node representing the first entity, a second node representing the second entity, a third node representing the third entity, and a user interface element of the third node, wherein the user interface element of the third node indicates that the third entity is associated with the third quantity of the resource; and
providing, via a user interface, the interactive graph.

Clause 18. A system comprising:
one or more computer-readable storage mediums storing program instructions; and
one or more processors configured to execute the program instructions to cause the system to perform the computerized method of any of Clauses 1-17.

Clause 19. One or more computer-readable storage mediums storing program instructions, the program instructions executable by one or more processors to cause the one or more processors to perform the computerized method of any of Clauses 1-17.

What is claimed is:

1. A computerized method, performed by a computing system having one or more hardware computer processors and one or more non-transitory computer-readable storage devices storing software instructions executable by the computing system, the computerized method comprising:
accessing a data store that stores at least hierarchy information indicative of a hierarchy associated with a plurality of entities comprising a first entity, a second entity, and a third entity;
receiving, from a first data source, first quantity information of a first resource used by the plurality of entities;
receiving, from a second data source, second quantity information of the first resource used by the plurality of entities;
determining, based on the hierarchy information indicative of the hierarchy, that the first entity and the second entity are in a lower level of the hierarchy and the third entity is in a higher level of the hierarchy;
determining, based at least in part on the first quantity information of the first resource and the second quantity information of the first resource, that (i) the first entity is associated with a first quantity of the first resource and (ii) the second entity is associated with a second quantity of the first resource;
based at least on the first quantity of the first resource and the second quantity of the first resource, determining that the third entity is associated with a third quantity of the first resource;
based at least on the hierarchy information, the first quantity of the first resource, the second quantity of the first resource, and the third quantity of the first resource, generating an interactive graph representing the hierarchy and comprising a first node representing the first entity, a second node representing the second entity, a third node representing the third entity, a user interface element of the first node, a user interface element of the second node, and a user interface of the third node, wherein the user interface element of the first node indicates that the first entity is associated with the first quantity of the first resource, the user interface element of the second node indicates that the second entity is associated with the second quantity of the first resource, and the user interface element of the third node indicates that the third entity is associated with the third quantity of the first resource; and
providing, via a user interface, the interactive graph.

2. The computerized method of claim 1, further comprising:
receiving a user operation, made via the user interface, on a first user interface element of the user interface and a second user interface element of the user interface, the first user interface element indicative of the first data source, the second user interface element indicative of the second data source, and the user operation comprising a selection of the first user interface element and a deselection of the second user interface element.

3. The computerized method of claim 2, further comprising, in response to receiving the user operation:
determining, based on the first quantity information rather than the second quantity information, that (i) the first entity is associated with a first updated quantity of the first resource and (ii) the second entity is associated with a second updated quantity of the first resource;
based at least on the first updated quantity and the second updated quantity, determining that the third entity is associated with a third updated quantity of the first resource; and
updating (i) the user interface element of the first node to indicate that the first entity is associated with the first updated quantity of the first resource, (ii) the user interface element of the second node to indicate that the second entity is associated with the second updated quantity of the first resource, and (iii) the user interface element of the third node to indicate that the third entity is associated with the third updated quantity of the first resource.

4. The computerized method of claim 1, wherein determining that (i) the first entity is associated with a first quantity of the first resource and (ii) the second entity is associated with a second quantity of the first resource comprises:
determining that the first quantity information conflicts with the second quantity information; and
in response to determining that the first quantity information conflicts with the second quantity information: using, based on a criterion, the first quantity information rather than the second quantity information to determine that (i) the first entity is associated with a first quantity of the first resource and (ii) the second entity is associated with a second quantity of the first resource.

5. The computerized method of claim 4, wherein the criterion indicates that the first data source is more trustworthy than the second data source, or the first data source is more recently updated than the second data source.

6. The computerized method of claim 1, wherein determining that the third entity is associated with the third quantity of the first resource comprises:
aggregating the first quantity and the second quantity to obtain the third quantity.

7. The computerized method of claim 1, further comprising:
adding into one or more databases a first data object of a first data object type, the first data object representing the first entity;
adding into the one or more databases a second data object of a second data object type, the second data object representing the second entity; and
adding into the one or more databases a third data object of a third data object type, the third data object representing the third entity.

8. The computerized method of claim 1, wherein the first entity represents a real-world department, division, team, unit, or personnel associated with an organization.

9. The computerized method of claim 1, further comprising:
receiving, from the first data source, first quantity information of a second resource used by the plurality of entities;
receiving, from the second data source, second quantity information of the second resource used by the plurality of entities;
determining, based at least in part on the first quantity information of the second resource and the second quantity information of the second resource, that (i) the first entity is associated with a first quantity of the second resource and (ii) the second entity is associated with a second quantity of the second resource;
based at least on the first quantity of the second resource and the second quantity of the second resource, determining that the third entity is associated with a third quantity of the second resource; and
updating the interactive graph to include a second user interface element of the first node, a second user interface element of the second node, and a second user interface of the third node, wherein the second user interface element of the first node indicates that the first entity is associated with the first quantity of the second resource, the second user interface element of the second node indicates that the second entity is associated with the second quantity of the second resource, and the second user interface element of the third node indicates that the third entity is associated with the third quantity of the second resource.

10. The computerized method of claim 9, further comprising:
receiving a user operation indicating a union of the first resource and the second resource to create a third resource comprising the first resource and the second resource; and
based at least in part on receiving the user operation:
determining, based on the first quantity of the first resource and the first quantity of the second resource, that the first entity is associated with a first quantity of the third resource;
determining, based on the second quantity of the first resource and the second quantity of the second resource, that the second entity is associated with a second quantity of the third resource;
based at least on the first quantity of the third resource and the second quantity of the third resource, determining that the third entity is associated with a third quantity of the third resource; and
updating the interactive graph to include a third user interface element of the first node, a third user interface element of the second node, and a third user interface of the third node, wherein the third user interface element of the first node indicates that the first entity is associated with the first quantity of the third resource, the third user interface element of the second node indicates that the second entity is associated with the second quantity of the third resource, and the third user interface element of the third node indicates that the third entity is associated with the third quantity of the third resource.

11. The computerized method of claim 1, further comprising:
receiving a user operation indicating an overwrite of the first quantity of the first resource using an overwriting number; and
in response to receiving the user operation, updating the user interface element of the first node to indicate that the first entity is associated with the overwriting number of the first resource.

12. The computerized method of claim 1, further comprising:
receiving a user operation, via the user interface, that configures one or more metrics for generating the interactive graph; and
in response to receiving the user operation, updating the interactive graph based on the one or more metrics.

13. The computerized method of claim 12, wherein the one or more metrics comprise a condition, a forecast, a trend, or a period of time for the forecast associated with the first resource.

14. The computerized method of claim 1, further comprising:
receiving a user operation, made via the user interface or another user interface, indicating a removal of the first entity from the hierarchy; and
in response to receiving the user operation, updating the interactive graph to at least remove the first node representing the first entity from the interactive graph.

15. The computerized method of claim 1, wherein the hierarchy information is stored in a data object of a data object type defined in an ontology of a database module.

16. The computerized method of claim 1, wherein the first resource comprises a material, a natural resource, an equipment, or a manpower.

17. A computerized method, performed by a computing system having one or more hardware computer processors and one or more non-transitory computer-readable storage devices storing software instructions executable by the computing system, the computerized method comprising:
receiving, from at least a data source, quantity information of a resource used by a plurality of entities that comprise a first entity, a second entity, and a third entity;
determining, based on hierarchy information indicative of a hierarchy associated with the plurality of entities, that the first entity and the second entity are in a lower level of the hierarchy and the third entity is in a higher level of the hierarchy;
determining, based at least in part on the quantity information of the resource, that (i) the first entity is associated with a first quantity of the resource and (ii) the second entity is associated with a second quantity of the resource;
based at least in part on the first quantity and the second quantity, determining that the third entity is associated with a third quantity of the resource;
based at least in part on the hierarchy information and the third quantity, generating an interactive graph representing the hierarchy and comprising a first node representing the first entity, a second node representing the second entity, a third node representing the third entity, and a user interface element of the third node, wherein the user interface element of the third node indicates that the third entity is associated with the third quantity of the resource; and
providing, via a user interface, the interactive graph.

18. A system comprising:
one or more computer-readable storage mediums storing program instructions; and
one or more processors configured to execute the program instructions to cause the system to perform the computerized method of claim 1.

19. One or more computer-readable storage mediums storing program instructions, the program instructions executable by one or more processors to cause the one or more processors to perform the computerized method of claim 1.
